(19) United States
(12) Patent Application Publication
(10) Pub. No.: US 2008/0124494 A1
(43) Pub. Date: May 29, 2008

(54) Double-Sided Pressure-Sensitive Adhesive Tapes for Producing Lc Displays with Light-Reflective and Absorbing Properties

(76) Inventors: Marc Husemann, Hamburg (DE); Reinhard Storbeck, Hamburg (DE)

Correspondence Address: NORRIS, MCLAUGHLIN & MARCUS, PA, 875 THIRD AVENUE, 18TH FLOOR, NEW YORK, NY, 10022, US

(21) Appl. No.: 11/720,365

(22) PCT Filed: Dec. 2, 2005
(86) PCT No.: PCT/EP2005/056399

§ 371 Date: Jul. 11, 2007

(30) Foreign Application Priority Data
Dec. 2, 2004 (DE) 10 2004 058 283.1

(51) Int. Cl. C09K 19/00; B32B 7/12; B29C 65/00

(52) U.S. Cl. 428/1.5; 428/344; 156/60

(57) ABSTRACT

The invention relates to a pressure-sensitive adhesive tape, particularly for producing or sticking together optical liquid crystal data displays (LCD's), comprising a top side and an underside, with light-reflective properties on the top side and light-absorbing properties on the underside. The pressure-sensitive adhesive tape also comprises a carrier film (a) with a top side and an underside, and the pressure-sensitive adhesive tape is provided with a pressure-sensitive adhesive layer (b, b′) on both sides. The pressure-sensitive adhesive tape is characterized in that the carrier film (a) is brightly colored, and the pressure-sensitive adhesive layer (b′) on the underside of the pressure-sensitive adhesive tape is colored black.

The invention relates to double-sided pressure-sensitive adhesive tapes having multilayer carrier constructions and having light-reflecting and light-absorbing properties for producing liquid-crystal displays (LCDs).

Pressure-sensitive adhesive tapes in the age of industrialization are widespread processing auxiliaries. Particularly for use in the computer industry, very exacting requirements are imposed on pressure-sensitive adhesive tapes. As well as having a low outgassing behavior, the pressure-sensitive adhesive tapes ought to be suitable for use across a wide temperature range and ought to fulfill certain optical properties.

One field of use is that of LC displays, which are needed for computers, TVs, laptops, PDAs, cell phones, digital cameras, etc. One very widespread type of an LCD module for such applications is shown in FIG. 1.

FIG. 1 shows the approach for a double-sided adhesive tape having a black layer for absorption and a white layer for reflection, in accordance with the prior art; the key to the reference numerals is as follows:

| | |
|---|---|
| 1 | LCD glass |
| 2 | double-sided black-white adhesive |
| | tape |
| 3 | pressure-sensitive adhesive |
| 4 | light source (LED) |
| 5 | light beams |
| 6 | double-sided adhesive tape |
| 7 | optical waveguide |
| 8 | reflective film |
| 9 | LCD casing |
| 10 | black absorbing side of adhesive tape |
| 11 | white reflecting side |
| 12 | visible region |
| 13 | “blind” region |

For the production of LC displays, LEDs (light-emitting diodes), as the light source, are bonded to the LCD glass. In general, black, double-sided pressure-sensitive adhesive tapes are used for this purpose. The aim of the black coloration is to prevent light penetrating from inside to outside and vice versa in the region of the double-sided pressure-sensitive adhesive tape. There are already numerous approaches in existence for achieving such black coloring.

On the other hand, there is a desire to increase the light efficiency of the back light module, and so it is preferred to use double-sided adhesive tapes which are black (light-absorbing) on one side and light-reflecting on the other side. For the production of the black side there are numerous approaches in existence.

One approach to the production of black double-sided pressure-sensitive adhesive tapes lies in the coloration of the carrier material. Within the electronics industry great preference is attached to using double-sided pressure-sensitive adhesive tapes having polyester film carriers (PET), on account of their very good diecuttability. The PET carriers can be colored with carbon black or other black pigments, in order to achieve light absorption. The disadvantage of this existing approach is the low level of light absorption. In very thin carrier layers it is possible to incorporate only a relatively small number of particles of carbon black or other black pigment, with the consequence that absorption of the light is incomplete. With the eye, and also with relatively intensive light sources (with a luminance of greater than 600 candelas) it is then possible to determine the deficient absorption.

Another approach to producing black double-sided pressure-sensitive adhesive tapes concerns the production of a two-layer carrier material by means of coextrusion. Carrier films are generally produced by extrusion. As a result of the coextrusion, as well as the conventional carrier material, a second, black layer is coextruded, fulfilling the function of light absorption. This approach too has a variety of disadvantages. For example, for extrusion it is necessary to use antiblocking agents, which then lead to what are called pinholes in the product. These pinholes are optical point defects (light passes through these holes) and adversely impact the functioning in the LCD.

A further problem is posed by the layer thicknesses, since the two layers are first of all shaped individually in the die and it is therefore possible overall to realize only relatively thick carrier layers, with the result that the film becomes relatively thick and inflexible and hence its conformation to the surfaces to be bonded is poor. Moreover, the black layer must likewise be relatively thick, since otherwise it is not possible to realize complete absorption. A further disadvantage lies in the altered mechanical properties of the carrier material, since the mechanical properties of the black layer are different from those of the original carrier material (e.g., pure PET). A further disadvantage of the two-layer version of the carrier material is the difference in anchoring of the adhesive to the coextruded carrier material. In this case, there is always a weak point in the double-sided adhesive tape.

In a further approach, a black colored coating layer is coated onto the carrier material. This coating may take place single-sidedly or double-sidedly on the carrier. This approach too has a variety of disadvantages. On the one hand, here as well, defects (pinholes) are readily formed, and are introduced by antiblocking agents during the film extrusion operation. These pinholes are unacceptable for the application in the LC display. Furthermore, the maximum absorption properties do not correspond to the requirements, since it is possible to apply only relatively thin coating films. Here as well, there is an upper limit on the layer thicknesses, since otherwise the mechanical properties of the carrier material would suffer alteration.

In the development of LC displays there is a trend developing. On the one hand, the LC displays are to become more lightweight and also flatter, and there is a rising demand for ever larger displays with ever higher resolution.

For this reason, the design of the displays has been changed, and the light source, accordingly, is coming nearer and nearer to the LCD panel, with the consequence of an increased risk of more and more light penetrating to the outside into the marginal zone (“blind area”) of the LCD panel (see FIG. 1). With this development, therefore, there is also an increase in the requirements imposed on the shading properties (blackout properties) of the double-sided adhesive tape, and accordingly there is a need for new approaches to the production of black adhesive tapes.

Moreover, the double-sided pressure-sensitive adhesive tape should be reflecting.

Known for this purpose are double-sided pressure-sensitive adhesive tapes which have a black light-absorbing layer and on one side a white or a metallic layer (cf. also FIG. 1 on the approach of a double-sided adhesive tape with a black layer for absorption and a white layer for reflection).

With these pressure-sensitive adhesive tapes, a distinct improvement has been obtained in respect of light reflection on one side and light absorption on the opposite side, and yet, as a result of the antiblocking agents in the carrier layer, irregularities occur in the reflecting side.

In general, double-sided pressure-sensitive adhesive tapes having a white and a black layer have operation advantages over double-sided pressure-sensitive adhesive tapes having a metallic and a black layer, since in the course of the positioning in the LCD it is easy for crease points to be incorporated into black/metallic pressure-sensitive adhesive tape diecuts, and these crease points then have a direct adverse effect on the reflection properties.

Certain approaches to the production of light-absorbing and light-reflecting double-sided adhesive tapes are likewise to be found in the patent literature.

To obtain a reflecting layer, it is possible to admix, for example, reflecting particles to the pressure-sensitive adhesive (PSA). The reflecting properties obtainable, however, are inadequate.

JP 2002-350612 describes double-sided adhesive tapes for LCD panels with light-protective properties. The function is achieved by means of a metal layer applied on one or both sides to the carrier film, it also being possible, additionally, for the carrier film to have been colored. The adhesive tapes described therein, however, have only this function, and thus do not combine the light-absorbing function on the one side and the light-reflecting function on the other side.

JP 2002-023663 likewise describes double-sided adhesive tapes for LCD panels that have light-protecting properties. Here again, the function is achieved by means of a metal layer applied on one or both sides to the carrier film.

DE 102 43 215 A describes double-sided adhesive tapes for LC displays that have light-absorbing properties on the one side and light-reflecting properties on the other side. That patent describes black/silver double-sided PSA tapes.

For the adhesive bonding of LCD displays and for their production, therefore, there continues to be a need for double-sided PSA tapes which do not have the deficiencies described above, or which have them only to a reduced extent.

It is therefore an object of the invention to provide a double-sided pressure-sensitive adhesive tape which avoids pinholes, and which is capable of fully absorbing light, and which has improved reflection of light.

In the context of this invention it has surprisingly been found that adhesive tapes of this kind can be produced by means of black-colored compositions, in particular with specific carbon black. A particular surprise was that it was possible to obtain an absolute black coloration even with very low levels of application of composition, so that the double-sided adhesive tape contained no pinholes, while retaining the adhesive properties and the suitability for the production of LCD modules.

The invention relates accordingly to pressure-sensitive adhesive tapes, in particular for the production or adhesive bonding of optical liquid-crystal displays (LCDs), having a top side and a bottom side, having light-reflecting properties on the top side and light-absorbing properties on the bottom side, further comprising a carrier film having a top side and a bottom side, the pressure-sensitive adhesive tape being furnished on both sides with a pressure-sensitive adhesive layer, and the carrier film being pale, in particular white, and the pressure-sensitive adhesive layer on the bottom side of the PSA tape being nontransparent, and in particular being colored black.

Described below are particularly advantageous embodiments of the invention, without any desire that the choice of the examples should unnecessarily restrict the invention.

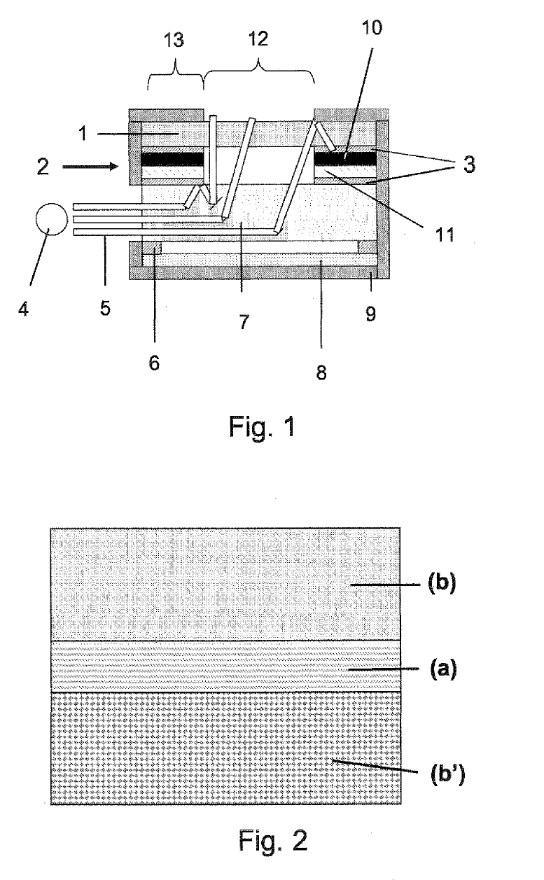

In the embodiment according to FIG. 2 the PSA tape of the invention is composed of a white carrier film layer (a), a transparent PSA layer (b) and a nontransparent PSA layer, in particular a layer colored with carbon black, (b)′.

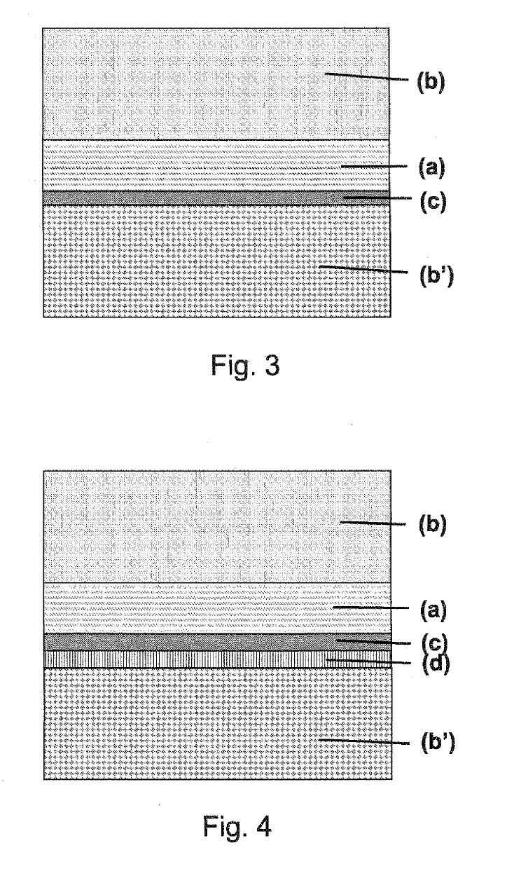

In another preferred embodiment of the invention the inventive PSA tape possesses the product construction shown in FIG. 3. Here, the double-sided PSA tape is composed of a white carrier film (a), a transparent pressure-sensitive adhesive layer (b) and a nontransparent pressure-sensitive adhesive layer, in particular a layer colored with carbon black, (b)′, and also a metallic layer (c).

FIG. 4 shows an embodiment in which the double-sided PSA tape is composed of a white carrier film (a), a metallically reflecting layer (c), a transparent pressure-sensitive adhesive layer (b) and a nontransparent pressure-sensitive adhesive layer, in particular a layer colored with carbon black, (b)′, and also a black-colored paint layer (d).

The PSA tapes of the invention may further be characterized as follows:

The carrier film (a) is preferably between 5 and 250 μm, more preferably between 8 and 50 μm, very preferably between 12 and 36 μm thick, is colored pale, in particular white, and is of very low translucency. The layer (c) is metallically lustrous and reduces the light absorption of the inventive PSA tape. To produce the layer (c), the film (a) is furnished with a silver-colored paint coating and/or, in one preferred embodiment of the invention, is vapor-coated on one side with aluminum or silver. The thickness of the layer (c) is preferably between 5 nm and 200 nm.

The layer (d) is a black-colored coating film which has a layer thickness, preferably, of between 0.01 and 5 μm.

The PSA layers (b) and (b′) may differ in their chemical nature. (b)′ contains different chromophoric pigments, which exert advantageous consequences for the light-absorbing properties and appear black.

The PSA layers (b) and (b′) preferably possess a thickness of in each case 5 μm to 250 μm. The layer thicknesses for the individual layers (b), (b′), (c) and (d) can differ within the double-sided PSA tape, and consequently it is possible, for example, to apply PSA layers differing in thickness; however, some or all of the layers may be formed to the same thickness, so that, for example, PSA layers of equal thickness may be advantageously present on both sides of the adhesive tape.

### Carrier Film (a)

As film carriers it is possible in principle to use all filmic polymer carriers which may be colored white. Thus it is possible, for example, to use polyethylene, polypropylene, polyimide, polyester, polyamide, polymethacrylate, fluorinated polymer films, etc. In one particularly preferred version, polyester films are used, more preferably PET (polyethylene terephthalate) films. The films may be present in detensioned form or may have one or more preferential directions. Preferential directions are obtained by drawing in one or in two directions.

For the preparation process for PET films, for example, antiblocking agents, such as silicon dioxide, siliceous chalk or other chalk, and zeolites, are usually used.

Particularly for very thin, for example, 12 μm thick PET films it is only possible to avoid pinholes if the PET film is coated with metal. Furthermore, up to 12 μm PET films are outstandingly suitable on account of the fact that they allow very good adhesive properties for the double-sided adhesive tape, since in this case the film is very flexible and is able to conform well to the surface roughnesses of the substrates that are to be bonded.

To improve the anchoring of the coating films or of the vapor-deposited metal the films are preferably pretreated. The films may be etched (e.g., using trichloroacetic or trifluoroacetic acid), corona- or plasma-pretreated, or furnished with a primer (e.g., Saran).

In addition, the film comprises colored pigments or chromophoric particles, which result in a white coloring. White pigments which can be used outstandingly are, for example, titanium dioxide, barium sulfate, calcium carbonate, zinc oxide, zinc sulfide and/or lead carbonate. For additions of titanium dioxide a distinction is made additionally between anatase and rutile structure. The differences are apparent, for example, in the refractive indices, the density, the hardness, and the photochemical activity.

Moreover, the white pigments can also be used in combination with organic pigments.

The pigments or particles ought, however, advantageously to be always smaller in diameter than the ultimately present layer thickness of the carrier film. Optimum colorations can be achieved with 5% to 40% by weight particle fractions, based on the film material.

### PSAs (b) and (b′)

The PSAs (b) and (b′) are preferably different on both sides of the PSA tape.

In general, PSA systems based on acrylate, natural-rubber, synthetic-rubber, silicone or EVA adhesives may be used as raw material basis. Where the double-sided inventive PSA tape has to have a high reflectance on at least one side, the PSA (b) ought to have a high transparency.

However, it is also possible in principle to use all further PSAs that are known to the skilled worker, as are cited for example in the “Handbook of Pressure Sensitive Adhesive Technology” by Donatas Satas (van Nostrand, New York 1989).

For (b) and (b′) it is possible, for example, to use natural rubber adhesives. Here, the natural rubber is milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV grades, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred embodiment use is preferably made for (b) and (b′) of (meth)acrylate PSAs.

(Meth)acrylate PSAs, which are obtainable by free-radical addition polymerization, consist to the extent of at least 50% by weight of at least one acrylic monomer from the group of the compounds of the following general formula:

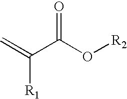

where R₁ is H or CH₃ and the radical R₂ is H or CH₃ or is selected from the group of branched or unbranched, saturated alkyl groups having 1-30 carbon atoms.

The monomers are preferably chosen such that the resulting polymers can be used, at room temperature or higher temperatures, as PSAs, particularly such that the resulting polymers possess pressure-sensitive adhesive properties in accordance with the “Handbook of Pressure Sensitive Adhesive Technology” by Donatas Satas (van Nostrand, New York 1989).

In a further inventive embodiment the comonomer composition is chosen such that the PSAs can be used as heat-activable PSAs.

The polymers can be obtained preferably by polymerizing a monomer mixture which is composed of acrylic esters and/or methacrylic esters and/or the free acids thereof, with the formula CH₂═CH(R₁)(COOR₂), where R₁ is H or CH₃ and R₂ is an alkyl chain having 1-20 carbon atoms or is H.

The molar masses M_{w} of the polyacrylates used amount preferably to M_{w}≧200 000 g/mol.

In one way which is greatly preferred, acrylic or methacrylic monomers are used which are composed of acrylic and methacrylic esters having alkyl groups comprising 4 to 14 carbon atoms, and preferably comprise 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethylhexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 carbon atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In one advantageous procedure monomers are used which carry polar groups such as carboxyl radicals, sulfonic and phosphonic acid, hydroxyl radicals, lactam and lactone, N-substituted amide, N-substituted amine, carbamate, epoxy, thiol, alkoxy or cyano radicals, ethers or the like.

Moderate basic monomers are, for example, N,N-dialkyl-substituted amides, such as, for example, N,N-dimethylacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, nonexclusively, of some examples: vinyl acetate, vinylformamide, vinylpyridine, ethyl vinyl ether, vinyl chloride, vinylidene chloride, and acrylonitrile.

Moreover, in a further procedure, use is made for the PSA (b) of photoinitiators having a copolymerizable double bond. Suitable photoinitiators include Norrish I and II photoinitiators. Examples include benzoin acrylate and an acrylated benzophenone from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized by a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

As a result of the increase in the aromatic fraction there is a rise in the refractive index of the PSA, and the scattering between LCD glass and PSA as a result, for example, of extraneous light is minimized.

For further development it is possible to admix resins to the PSAs. As tackifying resins for addition it is possible to use the tackifier resins already known and described in the literature. Representatives that may be mentioned include pinene resins, indene resins and rosins, their disproportionated, hydrogenated, polymerized, and esterified derivatives and salts, the aliphatic and aromatic hydrocarbon resins, terpene resins and terpene-phenolic resins, and also C₅, C₉, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on single monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989).

Here as well, the transparency of the PSA (c) is improved using, preferably, transparent resins which are highly compatible with the polymer. Hydrogenated or partly hydrogenated resins frequently feature these properties.

In addition it is possible optionally to add for the plasticizers, further fillers (such as, for example, fibers, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or aging inhibitors, in the form of, for example, primary and secondary antioxidants or in the form of light stabilizers. For the pressure-sensitive adhesive (b) such additives may be added only in amounts which do not affect the reflection of the metallic layer.

In a further variant of the invention, the PSAs (b) and (b′) differ only in the black particle addition. Thus the PSA (b′) contains preferably between 2% and 30% by weight of carbon black, more preferably between 5% and 20% by weight of carbon black, and very preferably between 8% and 15% by weight of carbon black. The carbon black has a light-absorbing function. Pigmentary carbon blacks have been found to be outstandingly suitable. One preferred embodiment uses carbon black powders from the company Degussa. These powders are available commercially under the trade name Printex™. For better dispersibility in the PSA it is particularly preferred to use carbon blacks which have been given an oxidative aftertreatment. For the PSA (b′) it may further be of advantage if color pigments are added as well as carbon black. Suitable additions thus include, for example, blue pigments, such as Anilinschwarz BS890 aniline black from Degussa. Furthermore, matting agents are other possible additions.

In another advantageous embodiment of the invention the PSAs (b) and (b′) differ not only in the black particle addition but also in their chemical composition. Thus it is possible, for example, to use different polyacrylates as the basic composition, differing in the comonomers and/or in the additization. For the layer (b′) it is also possible, furthermore, to make advantageous use, for example, of natural rubber or synthetic rubber adhesives and to combine them with a transparent acrylate PSA (b). For these embodiments the PSA (b′) likewise contains preferably between 2% and 30% by weight of carbon black, more preferably between 5% and 20% by weight of carbon black, and very preferably between 8% and 15% by weight of carbon black. The specific carbon blacks and/or color pigments stated in the preceding section are very advantageous here as well.

In addition it is possible to admix crosslinkers and promoters to the PSAs (b) and/or (b′) for crosslinking. Examples of suitable crosslinkers for electron beam crosslinking and UV crosslinking include difunctional or polyfunctional acrylates, difunctional or polyfunctional isocyanates (including those in block form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add in particular UV-absorbing photoinitiators to the PSAs (b) and/or (b′). Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and also others of the Norrish I or Norrish II type, can advantageously contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

### Preparation Process for the Acrylate PSAs

For the polymerization the monomers are advantageously chosen such that the resultant polymers can be used at room temperature or higher temperatures as PSAs, particularly such that the resulting polymers possess pressure-sensitive adhesive properties in accordance with the “Handbook of Pressure Sensitive Adhesive Technology” by Donatas Satas (van Nostrand, New York 1989).

In order to achieve a preferred polymer glass transition temperature T_{g} of ≦25° C. for PSAs it is very preferred, in accordance with the comments made above, to select the monomers in such a way, and choose the quantitative composition of the monomer mixture advantageously in such a way, as to result in the desired T_{g} for the polymer in accordance with an equation (E1) analogous to the Fox equation (E1) (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred version the free-radical initiator used is 1,1′-azobis(cyclohexanecarbonitrile) (Vazo 88™ from DuPont) or azodiisobutyronitrile (AIBN).

The average molecular weights M_{w} of the PSAs formed in the free-radical polymerization are very preferably chosen such that they are situated within a range of 200 000 to 4 000 000 g/mol; in particular, PSAs are prepared which have average molecular weights M_{w} of 400 000 to 1 400 000 g/mol. The average molecular weight is determined by size exclusion chromatography (GPC) or matrix-assisted laser desorption/ionization mass spectrometry (MALDI-MS).

The polymerization may be conducted without solvent, in the presence of one or more organic solvents, in the presence of water, or in mixtures of organic solvents and water. The aim is to minimize the amount of solvent used. Suitable organic solvents are straight alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether), and ethers (e.g. diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

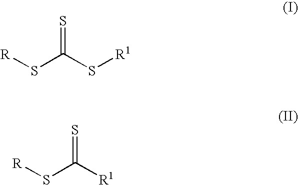

in which R and R¹ are chosen independently of one another or identical, and
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following compounds: halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

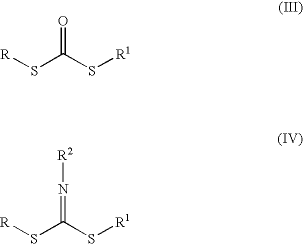

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hot-melt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

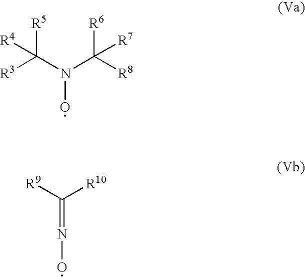

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂,
   where R¹¹, R¹² or R¹³ stand for radicals from group ii).

Compounds of type (Va) or (Vb) can also be attached to polymer chains of any kind (primarily such that at least one of the abovementioned radicals constitutes a polymer chain of this kind) and may therefore be used for the synthesis of polyacrylate PSAs. With greater preference, controlled regulators for the polymerization of compounds of the following types are chosen:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-piperidine-1-oxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6,-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates (Hawker, Contribution to the National Meeting of the American Chemical Society, Spring 1997; Husemann, Contribution to the IUPAC World-Polymer Meeting 1998, Gold Coast).

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Coating Process, Treatment of the Carrier Material

For preparation, in one preferred procedure the pressure-sensitive adhesive is coated from solution onto the carrier material. To increase the anchoring of the PSA it is possible optionally to pretreat the layers (a) and/or (b). Thus pretreatment may be carried out, for example, by corona or by plasma, a primer can be applied from the melt or from solution, or etching may take place chemically.

For the coating of the PSA from solution, heat is supplied, in a drying tunnel for example, to remove the solvent and, if appropriate, initiate the crosslinking reaction.

The polymers described above can also be coated, furthermore, as hotmelt systems (i.e., from the melt). For the preparation process it may therefore be necessary to remove the solvent from the PSA. In this case it is possible in principle to use any of the techniques known to the skilled worker. One very preferred technique is that of concentration using a single-screw or twin-screw extruder. The twin-screw extruder can be operated corotatingly or counterrotatingly. The solvent or water is preferably distilled off over two or more vacuum stages. Counterheating is also carried out depending on the distillation temperature of the solvent. The residual solvent fractions amount to preferably <1%, more preferably <0.5%, and very preferably <0.2%.

Moreover, the twin-screw extruder can also be used for compounding with the carbon black. In this way, the carbon black can be very finely divided in the pressure-sensitive adhesive matrix.

Further processing of the hotmelt very preferably takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, New York 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channels.

Through the coating it is also possible for the PSAs to undergo orientation.

In addition it may be necessary for the PSA to be crosslinked. In one preferred version, crosslinking takes place with electronic and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one embodiment, it is possible to crosslink the PSAs using electron beams. Typical irradiation equipment which can be employed includes linear cathode systems, scanner systems, and segmented cathode systems, where electron beam accelerators are employed. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably between 80 kV and 300 kV. The scatter doses employed range between 5 to 150 kGy, in particular between 20 and 100 kGy.

It is also possible to employ both crosslinking processes, or other processes allowing high-energy irradiation.

### Metallic Layer (c)

To produce a light-absorbing side one possibility is to apply a silver-colored paint to the film layer (a) and/or to vapor-coat the film layer (a) on one side with a metal, aluminum or silver for example. For the version with silver-colored paint, a binder matrix is blended with silver color pigments. Examples of suitable binder matrices include polyurethanes or polyesters which have a high refractive index and a high transparency. Alternatively the color pigments can be incorporated into a polyacrylate or polymethacrylate matrix and then cured as paint material.

In one very preferred version the film layer (a) is instead or additionally vapor-coated on one side with aluminum or silver. In order to achieve particularly outstanding reflecting properties, the sputtering operation for vapor coating ought to be controlled in such a way that the aluminum or silver is applied very evenly, in order to avoid pinholes.

In one very preferred embodiment this is achieved by means of a plasma-pretreated PET film which is vapor-coated with aluminum in one workstep. The use of the metallic layer (c) reduces or sharply lowers the transmission of the light through the carrier material, and surface roughnesses of the carrier film are compensated.

### Color Layers (d)

The color layer (d) may fulfill a variety of functions. In a preferred embodiment of the invention the color layer possesses the function of additional absorption of external light. In this case, therefore, for the double-sided PSA tape, the transmittance in a wavelength range of 300-800 nm ought to be <0.5%, more preferably <0.1%, very preferably <0.01%. With particular advantage this is achieved with a black paint layer. In a curing binder matrix (preferably a thermocuring system, but a radiation-curing system is also possible), black color pigments are mixed into the paint matrix. Paint materials used may be, for example, polyesters, polyurethanes, polyacrylates or polymethacrylates, in conjunction with the paint additives known to the skilled worker. In one procedure which is very preferred in the sense of the invention, carbon black or graphite particles are mixed as coloring particles into the binder matrix. As a result of this additization, and in the case of a very high level of additization (>20% by weight), electrical conductivity is achieved in addition to complete light absorption, so that the inventive double-sided PSA tapes likewise have antistatic properties.

The invention further provides for the use of the inventive double-sided pressure-sensitive adhesive tapes for adhesive bonding or production of optical liquid-crystal displays (LCDs), their use for the adhesive bonding of LCD glasses, and liquid-crystal displays and devices having liquid-crystal displays having an inventive pressure-sensitive adhesive tape in their construction. For use as pressure-sensitive adhesive tape it is possible for the double-sided pressure-sensitive adhesive tapes to have been lined with one or two release films and/or release papers. Preferably, use is made of siliconized or fluorinated films or papers, such as glassine, HDPE or LDPE coated papers, for example, which have in turn been given a release coat based on silicones or fluorinated polymers.

### EXAMPLES

The invention is described below, without wishing any unnecessary restriction to result from the choice of the examples.

The following test methods were employed.

### Test Methods

### A. Transmittance

The transmittance was measured in the wavelength range from 190 to 900 nm using a Uvikon 923 from Biotek Kontron. The absolute transmittance is reported in % as the value at 550 nm.

### B. Pinholes

A very strong light source of commercially customary type (e.g., Liesegangtrainer 400 KC type 649 overhead projector, 36 V halogen lamp, 400 W) is given completely lightproof masking. This mask contains in its center a circular aperture having a diameter of 5 cm. The double-sided LCD adhesive tape is placed atop said circular aperture. In a completely darkened environment, the number of pinholes is then counted electronically or visually. When the light source is switched on, these pinholes are visible as translucent dots.

### C. Reflection

The reflection test is carried out in accordance with DIN standard 5063 part 3. The instrument used was a type LMT Ulbrecht sphere. The reflectance is reported as the sum of directed and scattered light fractions in %.

### Polymer 1

A 200 l reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel) in solution in each case in 800 g of acetone were added. The reaction was terminated after a reaction time of 24 h, and the reaction mixture cooled to room temperature.

### Carbon Black Composition 1

In a drum the polymer 1 is diluted with special-boiling-point spirit to a solids content of 30%. Subsequently 8% by weight of carbon black (pigmentary carbon black, Printex™ 25, Degussa AG), based on the polymer 1, is mixed in with vigorous stirring. For homogenization the solution is homogenized for 10 minutes using an Ultraturrax.

### Carbon Black Composition 2

In a drum the polymer 1 is diluted with special-boiling-point spirit to a solids content of 30%. Subsequently 10% by weight of carbon black (pigmentary carbon black, Printex™ 25, Degussa AG), based on the polymer 1, is mixed in with vigorous stirring. For homogenization the solution is homogenized for 10 minutes using an Ultraturrax.

### Carbon Black Composition 3

In a drum the polymer 1 is diluted with special-boiling-point spirit to a solids content of 30%. Subsequently 12% by weight of carbon black (pigmentary carbon black, Printex™ 25, Degussa AG), based on the polymer 1, is mixed in with vigorous stirring. For homogenization the solution is homogenized for 10 minutes using an Ultraturrax.

### Crosslinking

The carbon black compositions and polymer 1 are coated from solution onto a siliconized release paper (PE coated release paper from Loparex), dried in a drying cabinet at 100° C. for 10 minutes, and then crosslinked with a dose of 25 kGy at an acceleration voltage of 200 kV. The coatweight was in each case 50 g/m².

### Film 1 (Al Vapor Coating):

A 38 μm PET film, extruded with white pigments as filler, from Toray (Lumirror™ 38E20) was vapor coated on one side with aluminum until a complete layer of aluminum has been applied to one side. The film was vapor-coated in a width of 300 mm by the sputtering method. In this method, positively charged, ionized argon gas is passed into a high-vacuum chamber. The charged ions then impinge on a negatively charged Al plate and, at the molecular level, detach particles of aluminum, which then deposit on the polyester film which is passed over the plate.

### Film 2:

38 μm PET film, extruded with white pigments as filler, from Toray (Lumirror™ 38E20).

### Example 1

Film 1 is coated by lamination with polymer 1 on one side at 50 g/m² and on the metal-coated side with carbon black composition 1 at 50 g/m².

### Example 2

Film 1 is coated by lamination with polymer 1 on one side at 50 g/m² and on the metal-coated side with carbon black composition 2 at 50 g/m².

### Example 3

Film 1 is coated by lamination with polymer 1 on one side at 50 g/m² and on the metal-coated side with carbon black composition 3 at 50 g/m².

### Example 4

Film 2 is coated by lamination with polymer 1 on one side at 50 g/m² and on the other side with carbon black composition 1 at 50 g/m².

### Example 5

Film 2 is coated by lamination with polymer 1 on one side at 50 g/m² and on the other side with carbon black composition 2 at 50 g/m².

### Example 6

Film 2 is coated by lamination with polymer 1 on one side at 50 g/m² and on the other side with carbon black composition 3 at 50 g/m².

### Results

Examples 1 to 6 were tested in accordance with test methods A, B, and C. The results are set out in Table 1.

TABLE 1

| | Transmittance | Pinholes | Reflectance (total) |
|---|---|---|---|
| Example | (test A) | (test B) | (test C) |
| 1 | <0.1% | 0 | 83.5% |
| 2 | <0.1% | 0 | 83.1% |
| 3 | <0.1% | 0 | 80.2% |
| 4 | <0.1% | 0 | 82.8% |
| 5 | <0.1% | 0 | 81.9% |
| 6 | <0.1% | 0 | 82.3% |

From the results in Table 1 it is apparent that examples 1 to 6 have an extremely low transmittance of <0.1% in test (A).

The number of pinholes was determined in test (B). Pinholes could not be found for any of the examples mentioned. Moreover, the reflectance of the white side was determined. In all cases, the reflectance was greater than 80%.

The results show that a high light yield can be achieved with the adhesive tapes of the invention in the case of LCD application.

1. A pressure-sensitive adhesive tape comprising a carrier film having a top side and a bottom side, a metallically reflecting coating on at least one of the sides and a pressure-sensitive adhesive layer directly or indirectly applied on both sides, wherein the carrier film is pale colored, the pressure-sensitive adhesive layer on a bottom side of the pressure-sensitive adhesive tape is colored black and the pressure-sensitive adhesive tape exhibits light-reflecting properties on a top side and light-absorbing properties on the bottom side.

2. The pressure-sensitive adhesive tape of claim 1, wherein the pale coloration of the carrier layer is achieved through the presence of white pigments.

3. The pressure-sensitive adhesive tape of claim 1, wherein the black coloration of the pressure-sensitive adhesive layer on the bottom side is brought about by means of carbon black.

4. The pressure-sensitive adhesive tape of claim 1, which comprises the following layer sequence: transparent pressure-sensitive adhesive layer (b)—pale, in particular white, carrier film layer (a)—nontransparent pressure-sensitive adhesive layer.

5. The pressure-sensitive adhesive tape of claim 1, which comprises the following layer sequence: transparent pressure-sensitive adhesive layer (b)—pale carrier film layer (a)—metallically reflecting layer (c)—nontransparent pressure-sensitive adhesive layer.

6. The pressure-sensitive adhesive tape of claim 1, which comprises the following layer sequence: transparent pressure-sensitive adhesive layer (b)—pale carrier film layer (a)—metallically reflecting layer (c)—black-colored paint layer (d)—nontransparent pressure-sensitive adhesive layer.

7. A method of bonding components of an optical liquid-crystal display comprising bonding said components with a pressure-sensitive adhesive tape of claim 1.

8. The method of claim 7, wherein said components are components of LCD glasses.

9. A liquid-crystal display device comprising a pressure-sensitive adhesive tape of claim 1.
